(19) United States
(12) Patent Application Publication
(10) Pub. No.: US 2013/0113490 A1
(43) Pub. Date: May 9, 2013

(54) APPARATUS AND METHOD FOR DIRECTIONAL RESISTIVITY MEASUREMENT WHILE DRILLING USING INCOMPLETE CIRCULAR ANTENNA

(71) Applicants: Zhong Wang, Houston, TX (US); Wei Ren, Houston, TX (US); Huaping Wang, Houston, TX (US); Suming Wu, Sugar Land, TX (US); Allen Liu, Bellevue, WA (US)

(72) Inventors: Zhong Wang, Houston, TX (US); Wei Ren, Houston, TX (US); Huaping Wang, Houston, TX (US); Suming Wu, Sugar Land, TX (US); Allen Liu, Bellevue, WA (US)

(21) Appl. No.: 13/462,736

(22) Filed: May 2, 2012

Related U.S. Application Data
(60) Provisional application No. 61/528,800, filed on Aug. 30, 2011.

(51) Int. Cl. G01V 3/30

(52) U.S. Cl. 324/338

(57) ABSTRACT

An apparatus for making directional resistivity measurements of a subterranean formation includes a resistivity tool body with a longitudinal axis and an outer surface, a first antenna with two open ends deployed below the outer surface, a second antenna deployed below the outer surface and spaced at an axial distance from the first antenna, and at least one slot formed on the outer surface. A corresponding method for making directional resistivity measurements includes rotating a resistivity tool in a borehole, utilizing a transmitter-receiver antenna group formed in the resistivity tool to process an electromagnetic wave, and computing a resistivity-related measurement from the electromagnetic wave received on the receiver antenna.

### CROSS-REFERENCE TO RELATED APPLICATION(S)

The present invention claims the benefits of the filing date of U.S. Provisional Patent Application Ser. No. 61/528,800, filed on Aug. 30, 2011, the disclosure of which is hereby incorporated by reference in its entirety.

### FIELD OF THE INVENTION

The present invention relates generally to the field of electrical resistivity well logging. More particularly, the invention relates to an apparatus and a method for providing a directional resistivity tool with an incomplete circular antenna to make directional resistivity measurements of a subterranean formation.

### BACKGROUND OF THE INVENTION

The use of electrical measurements for gathering of downhole information, such as logging while drilling (“LWD”), measurement while drilling (“MWD”), and wireline logging system, is well known in the oil industry. Such technology has been utilized to obtain earth formation resistivity (or conductivity; the terms “resistivity” and “conductivity”, though reciprocal, are often used interchangeably in the art.) and various rock physics models (e.g. Archie's Law) can be applied to determine the petrophysical properties of a subterranean formation and the fluids therein accordingly. As known in the prior art, the resistivity is an important parameter in delineating hydrocarbon (such as crude oil or gas) and water contents in the porous formation.

Ordinarily, a well is drilled vertically and is substantially perpendicular to the layers of geological formation. A LWD or MWD tool for measuring the resistivity of the surrounding formation does not need to be azimuthally designed, as the formation surrounding the borehole is essentially the same in all directions. The rotation of LWD or MWD tool has no significant effect on the measured resistivity. For this reason, a conventional resistivity tool usually includes a receiver coil spaced at various axial distances from one or more transmitter coils as shown in FIG. 1A, and both receiver and transmitter coils are oriented so as to transmit/receiver axial electromagnetic waves in the direction parallel to the longitudinal axis of the resistivity tool. Alternating current in the transmitter coil produces corresponding alternating electromagnetic fields in the formation. Voltages are induced on the receiver coil as a result of electromagnetic induction phenomena related to the alternating electromagnetic fields induced in the formation surrounding the borehole. The measured voltage can be processed, as known in the prior art, to estimate formation resistivity.

However, a “horizontal drilling,” which means drilling wells at less of an angle with respect to the geological formation, is getting popular, because it can increase exposed length of the pay zone (the formation with hydrocarbons) and overcome difficulties of vertical drilling. When drilling horizontally, it is preferable to keep the borehole in the pay zone as much as possible so as to maximize the recovery. Therefore, a directional resistivity tool with azimuthal sensitivity is needed to make steering decisions for subsequent drilling of the borehole. The steering decisions can be made upon measurement results of bed boundary identification, formation angle detection, and fracture characterization.

Directional resistivity measurements commonly involve transmitting and/or receiving transverse (x-mode or y-mode) or mixed mode (e.g. mixed x- and z-mode) electromagnetic waves. Various antenna configurations are well known for making such measurements, such as a transverse antenna configuration (x-mode) shown in FIG. 1B, a bi-planer antenna configuration shown in FIG. 1C, a saddle antenna configuration (x-mode and z-mode, mixed mode) shown in FIG. 1D, and a tilted antenna shown in FIG. 1E.

All of the above prior arts at least have a portion of the antenna wires are oriented non-perpendicular to the longitudinal axis of the directional resistivity tool. The introduction of transverse mode antenna or mixed mode antenna increases both complexity and cost of mechanical fabrication.

As described above, although the directional resistivity tools have been used commercially, a need still exists for an improved antenna configured in a directional resistivity tool.

A further need exists for an improved antenna configuration which is easy to manufacture and assemble with a directional resistivity tool.

A further need exists for an improved antenna configuration with good durability and reliability.

A further need exists for an improved antenna configuration which is cost effective.

The present embodiments of the apparatus and the method meet these needs, and improve on the technology.

### SUMMARY OF THE INVENTION

This section provides a general summary of the disclosure, and is not a comprehensive disclosure of its full scope or its entire feature.

In one preferred embodiment, an apparatus for making directional resistivity measurements of a subterranean formation can include a resistivity tool body with a longitudinal axis and an outer surface, a first antenna with two open ends deployed below the outer surface and oriented substantially perpendicular to the longitudinal axis of the resistivity tool body, a second antenna deployed below the outer surface and spaced at an axial distance from the first antenna, and at least one slot formed on the outer surface.

In some embodiments, the slot is oriented substantially parallel to the longitudinal axis of the resistivity tool body.

In some embodiments, the second antenna is oriented perpendicular to the longitudinal axis of the resistivity tool body.

In some embodiments, the first antenna operates as a transmitter antenna to transmit an electromagnetic wave or as a receiver antenna to receive the electromagnetic wave.

In some embodiments, the second antenna operates as the receiver antenna while the first antenna operates as the transmitter antenna

In some embodiments, the second antenna operates as the transmitter antenna while the first antenna operates as the receiver antenna.

In some embodiments, the first antenna is a wire segment deployed substantially perpendicular to the longitudinal axis of the resistivity tool body.

In still some embodiments, the first antenna is an incomplete circular antenna deployed substantially perpendicular to the longitudinal axis of the resistivity tool body.

In other embodiments, the second antenna is a wire loop deployed substantially perpendicular to the longitudinal axis of the resistivity tool body.

In other embodiments, pathways of the first antenna and the second antenna traverse the slot.

In still other embodiments, the apparatus for making directional resistivity measurements of a subterranean formation can further include a permeable material filled in the slot.

In another embodiment, the permeable material is a magnetic material for enhancing transmission and reception of the first antenna and the second antenna.

In another embodiment, the magnetic material is selected from the group consisting of a ferrite material, an electrically non-conductive magnetic alloy, an iron powder, and a nickel iron alloy.

In still another embodiment, the apparatus for making directional resistivity measurements of a subterranean formation can further include a protective material filled in the slot of the resistivity tool body.

In still another embodiment, the protective material is made of epoxy resin.

In one preferred embodiment, a directional resistivity tool with a tool body and a longitudinal axis can include a wire segment with two open ends placed in the tool body and configured to transmit or receive an electromagnetic wave, a wire loop placed in the tool body and configured to receive or transmit the electromagnetic wave from or to the wire segment, at least one slot formed on the periphery of the tool body for housing the wire segment and the wire loop, and the wire segment formed substantially perpendicular to the longitudinal axis of the tool body.

In some embodiments, the directional resistivity tool can further include a permeable material filled in the slot.

In still some embodiments, the wire segment and the wire loop operate as an antenna at one or more frequencies.

In one preferred embodiment, a method for making directional resistivity measurements of a subterranean formation can include rotating a resistivity tool in a borehole, the resistivity tool including a first antenna with two open ends oriented substantially perpendicular to a longitudinal axis of the resistivity tool, a second antenna, and the first antenna and the second antenna forming a transmitter-receiver antenna group having a transmitter antenna and a receiver antenna, utilizing the transmitter-receiver antenna group to process an electromagnetic wave, including causing the transmitter antenna to transmit the electromagnetic wave and causing the receiver antenna to receive the electromagnetic wave from the transmitter antenna, and computing a resistivity-related measurement from the electromagnetic wave received on the receiver antenna.

In some embodiments, computing the resistivity-related measurement can include extracting an average value of induced voltages on the receiver antenna during a rotation round of the resistivity tool.

In some embodiments, computing the resistivity-related measurement can further include processing the average value of induced voltages to derive a resistivity of the subterranean formation adjacent to the borehole.

In other embodiments, computing the resistivity-related measurement can include extracting a peak-valley amplitude of induced voltages on the receiver antenna during a rotation round of the resistivity tool and a rotation angle.

In another embodiment, computing the resistivity-related measurement can further include processing the peak-valley amplitude to derive information of distance and direction to an interface from the resistivity tool.

### BRIEF DESCRIPTION OF THE DRAWINGS

The drawings described herein are for illustrating purposes only of selected embodiments and not all possible implementation and are not intended to limit the scope of the present disclosure.

The detailed description will be better understood in conjunction with the accompanying drawings as follows:

FIG. 1A illustrates a prior art of a conventional resistivity tool with a pair of a transmitter antenna and a receiver antenna.

FIGS. 1B, 1C, 1D, and 1E illustrate prior arts of antenna embodiments for making directional resistivity measurements.

FIG. 2 illustrates a front view of a directional resistivity tool 212 assembled with a conventional logging while drilling system 200.

FIG. 3 illustrates a perspective view of the directional resistivity tool 212 shown in FIG. 2.

FIG. 4A illustrates a cross-sectional view of the directional resistivity tool 212 taken along line AA′ in FIG. 3.

FIG. 4B illustrates a cross-sectional view of the directional resistivity tool 212 taken along line BB′ in FIG. 3.

FIG. 4C illustrates a cross-sectional view of a directional resistivity tool 212 applied with a protective material 406 in the slot 306.

FIGS. 5A, 5C and 5E illustrate the power strength in logarithm scale 10*log10(|E|*|H|) in azimuthal direction at a distance of 0.5 m with an open angle of 30 degrees, 90 degrees, and 180 degrees respectively.

FIGS. 5B, 5D, and 5F illustrate the power strength in logarithm scale 10*log10(|E|*|H|) in azimuthal direction at a distance of 5 m with an open angle of 30 degrees, 90 degrees, and 180 degrees respectively.

FIG. 6 illustrates the first model 600 used for demonstrating the azimuthal sensitivity of the present invention.

FIG. 7A illustrates simulation results of the model in FIG. 6 in term of a data graph of induced voltage of the second antenna 302 shown in FIG. 3 versus rotation angle of the directional resistivity tool 212.

FIG. 7B illustrates simulation results of the model in FIG. 6 in term of a data graph of induced voltage of the third antenna 304 shown in FIG. 3 versus rotation angle of the directional resistivity tool 212.

FIG. 8 illustrates simulation results of the model in FIG. 6 in terms of a data graph of average induced voltages of the second antenna 302 and of the third antenna 304 shown in FIG. 3 versus distance from the directional resistivity tool 212 to the resistivity interface 602.

FIG. 9A illustrates simulation results of the model in FIG. 6 in terms of a data graph of induced voltage amplitude ratio of the second antenna 302 to the third antenna 304 shown in FIG. 3 versus resistivity of surrounding formation of the directional resistivity tool 212.

FIG. 9B illustrates simulation results of the model in FIG. 6 in terms of a data graph of induced voltage phase shift between the second antenna 302 and the third antenna 304 shown in FIG. 3 versus resistivity of surrounding formation of the directional resistivity tool 212.

FIG. 10 illustrates the second model 1000 used for demonstrating the azimuthal sensitivity of the present invention.

FIG. 11A illustrates simulation results of the model in FIG. 10 in terms of a data graph of induced voltage of the second antenna 302 shown in FIG. 3 versus rotation angle of the directional resistivity tool 212.

FIG. 11B illustrates simulation results of the model in FIG. 10 in terms of a data graph of induced voltage of the third antenna 304 shown in FIG. 3 versus rotation angle of the directional resistivity tool 212.

FIG. 12 illustrates a flow chart of making directional resistivity measurements 1200 according to the present invention.

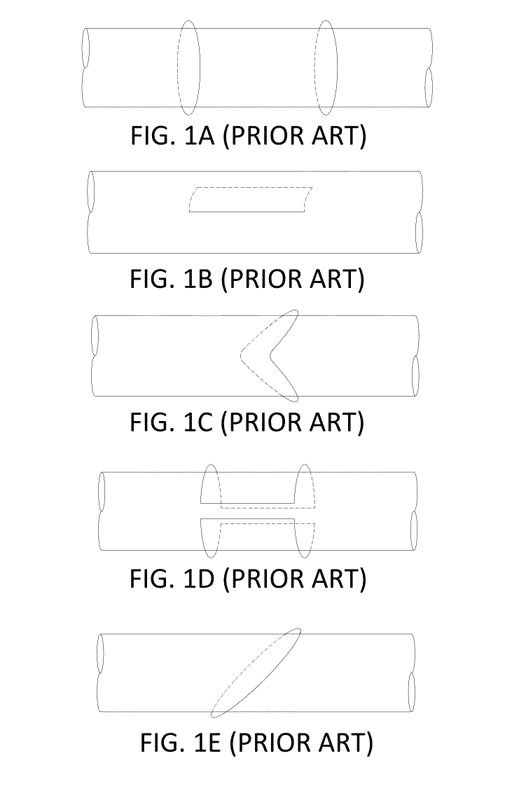

The present embodiments are detailed below with reference to the listed Figures.

### DETAILED DESCRIPTION OF THE EMBODIMENTS

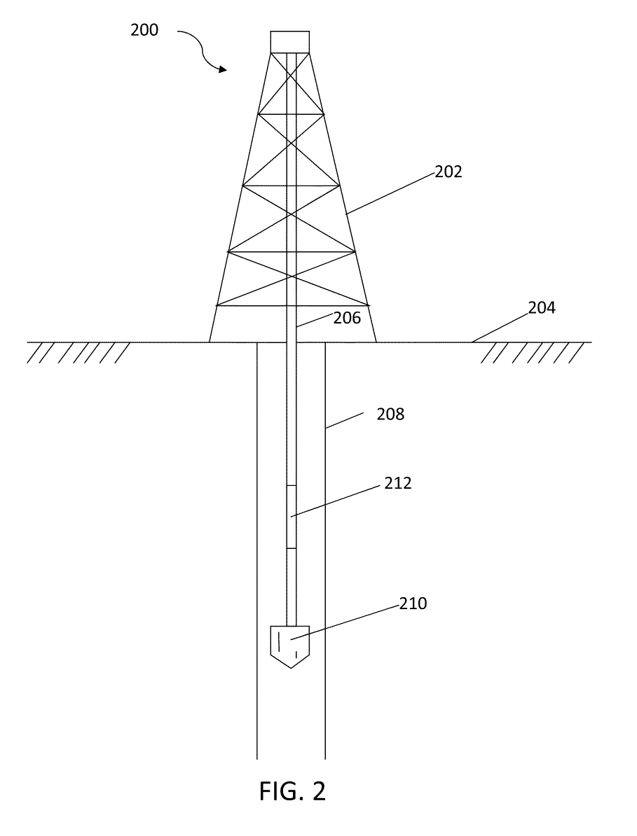

FIG. 2 illustrates a front view of a directional resistivity tool 212 assembled with a conventional logging while drilling system 200 according to some embodiments of the present invention. The conventional logging while drilling system 200 can include a drilling rig 202, a drill string 206, a drill bit 210, and a directional resistivity tool 212. The drill string 206 supported by the drilling rig 202 can extend from above a surface 204 down into a borehole 208. The drill string 206 can carry on the drill bit 210 and the directional resistivity tool 212 to make measurements of geological properties of a subterranean formation while drilling.

In some embodiments, the drill string 206 can further carry on a mud pulse telemetry system, a borehole drill motor, measurement sensors, such as a nuclear logging instrument, and an azimuth sensor, such as an accelerometer, a gyroscope, or a magnetometer, for facilitating measurements of surrounding formation. Also, the drill string 206 can be assembled with a hoisting apparatus for elevating or lowering the drill string 206.

The directional resistivity tool 212 according to the present invention can be applied not only to a logging while drilling (“LWD”) system, but also to a measurement while drilling (“MWD”) system and wireline applications. Also, the directional resistivity tool 212 can be equally suited for use with any kind of drilling environment, either onshore or offshore, and with any kind of drilling platform, including but not limited to, fixed, floating, and semi-submerge platforms.

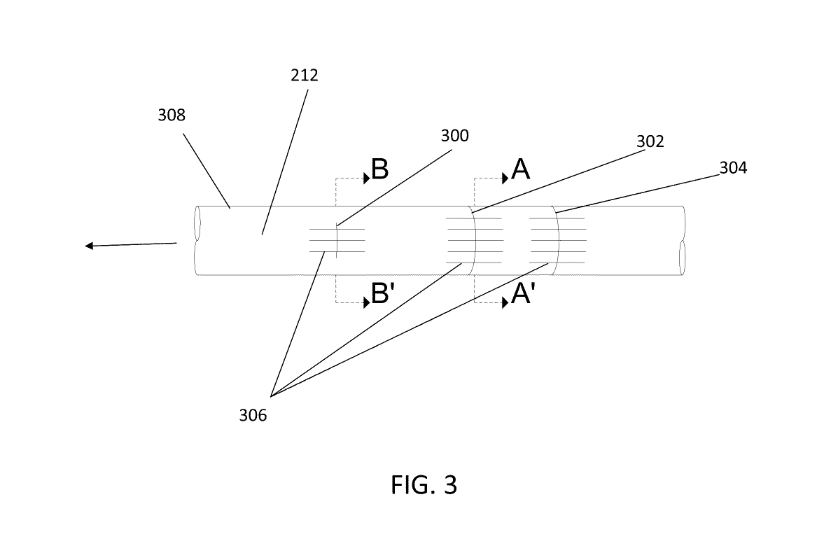

FIG. 3 illustrates a perspective view of the directional resistivity tool 212 shown in FIG. 2 according to some embodiments of the present invention. The directional resistivity tool 212 can include a first antenna 300, a second antenna 302, slots 306, and optionally a third antenna 304. The first antenna 300, the second antenna 302, and the third antenna 304 can be deployed below an outer surface 308, spaced at axial distance from each other, and oriented substantially perpendicular to the longitudinal axis of the directional resistivity tool 212. The slots 306 can be formed on the outer surface 308, and oriented substantially parallel to the longitudinal axis of the directional resistivity tool 212 and substantially perpendicular to the first antenna 300, the second antenna 302, and the third antenna 304.

In some embodiments, the slots 306 can be substantially around the entire periphery of the directional resistivity tool 212. In still some embodiments, the slots 306 can be formed on the outer surface 308 in any orientation. In another embodiment, the second and antenna 302 and the third antenna 304 can be deployed below the outer surface 308 in any orientation and shape. The present invention is in no way limited to any particular geometry and number of such slots and antennas.

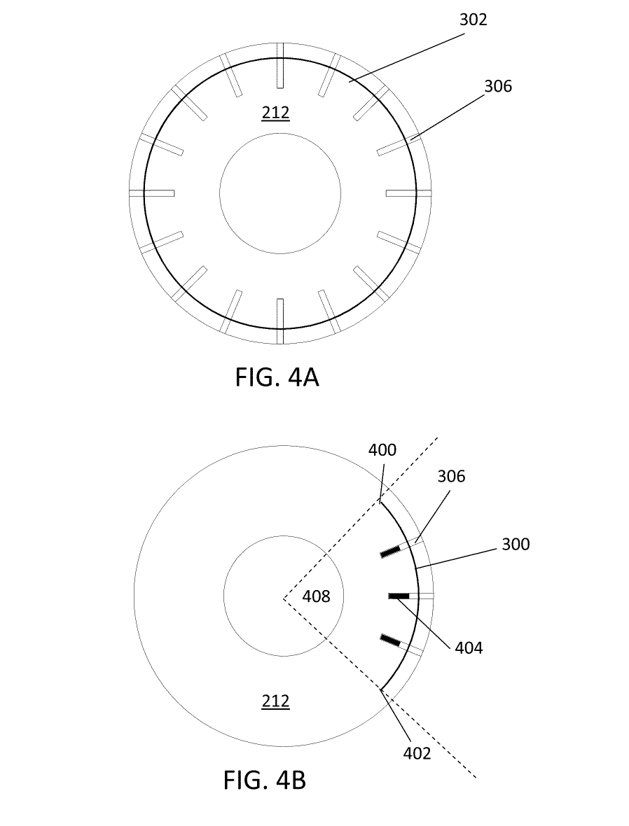

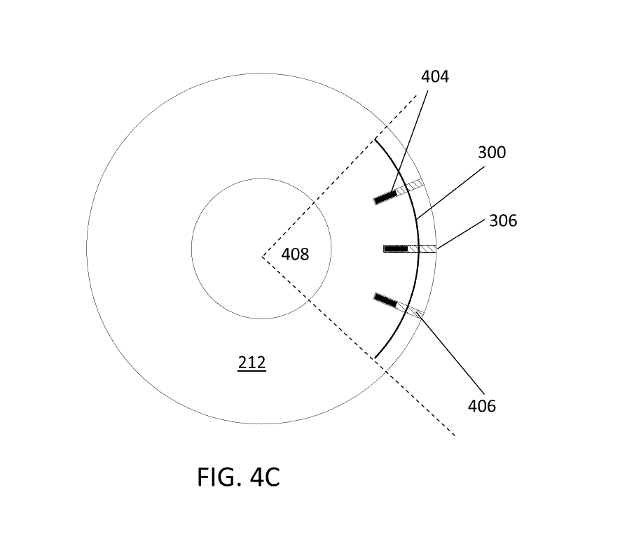

FIG. 4A illustrates a cross-sectional view of the directional resistivity tool taken along line AA′ in FIG. 3, and FIG. 4B illustrates a cross-sectional view of the directional resistivity tool taken along line BB′ in FIG. 3. FIG. 4A clearly shows that the second antenna 302 can be shaped as a current-carrying coil which constitutes a complete circular wire loop. Therefore, the second antenna 302 can be operated as a conventional coil antenna, being a magnetic source, which is axially symmetrical with respect to the longitudinal axis of the directional resistivity tool 212 and has no azimuthal sensitivity. In contrast to FIG. 4A, the first antenna 300 shown in FIG. 4B is configured as a current-carrying wire segment with a first end 400 and a second end 402 which constitutes an incomplete circular antenna. Therefore, it can be treated as an electric antenna. The slots 306 in FIGS. 4A and 4B can be traversed by pathways of the second antenna 302 and the first antenna 300. The purpose of the slots 306 can be to ensure there is no electrically conductive loop about the slots 306 and enable an antenna to transmit or receive electromagnetic field.

In some embodiments, a permeable material 404 can be filled in the slots 306 as shown in FIGS. 4B and 4C. The permeable material 404 can be a magnetic material for enhancing transmission and reception of the antennas. The magnetic material can be, but not limited to, a ferrite material, an electrically non-conductive magnetic alloy, an iron powder, and a nickel iron alloy.

In some embodiments, the slot 306 of the directional resistivity tool 212 can be filled with a protective material 406 as shown in FIG. 4C. The protective material 406 can be for protecting the electrical instruments formed in the directional resistivity tool 212 from damages caused while drilling. The protective material 406 can be, but not limited to, epoxy resin. The quantity of the protective material 406 and the permeable material 404 can be varied. Therefore, the interface between the protective material 406 and the permeable material 404 can be higher or lower than the pathway of the first antenna 300.

In FIG. 3 and FIG. 4, the first antenna 300 acts as a transmitter antenna for transmitting electromagnetic waves and the second antenna 302 and the third antenna 304 act as receiver antennas for receiving electromagnetic waves from the transmitter antenna during the rotation of the directional resistivity tool 212. Such an arrangement can enable the acquisition of compensated resistivity measurements. However, in accordance with the principle of reciprocity, each antenna may be able to act as either a transmitter antenna or a receiver antenna or a transmitter antenna and a receiver antenna at the same time as long as coupled with appropriate transmitter or receiver electronics. Thus, the first antenna 300 can also act as a receiver antenna and the second antenna 302 and the third antenna 304 can also act as transmitter antennas. Also however, the present invention is not limited to any particular transmitter or receiver spacing, nor to the use of compensated or uncompensated measurements.

In operation, the first antenna 300 with an incomplete circular shape can break the axial symmetry with respect to the longitudinal axis of the directional resistivity tool 212 and therefore it can have azimuthal sensitivity. During drilling, the polarization of the first antenna 300, as a transmitter antenna, can spatially vary with the rotation of the directional resistivity tool 212. When the directional resistivity tool 212 approaches a resistivity interface, the spatially-varying polarization of the first antenna 300 would cause a sinusoidal change of the induced voltages with the rotation of the directional resistivity tool 212 reflected on the second antenna 302 and/or the third antenna 304, as a receiver antenna. The sinusoidal variation of the induced voltages can contain the information of direction and distance to the resistivity interface and resistivity of surrounding formation.

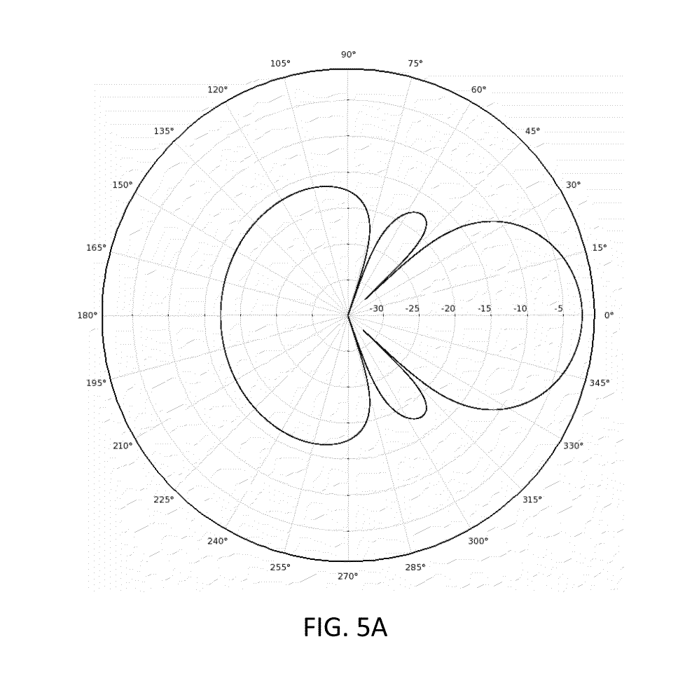

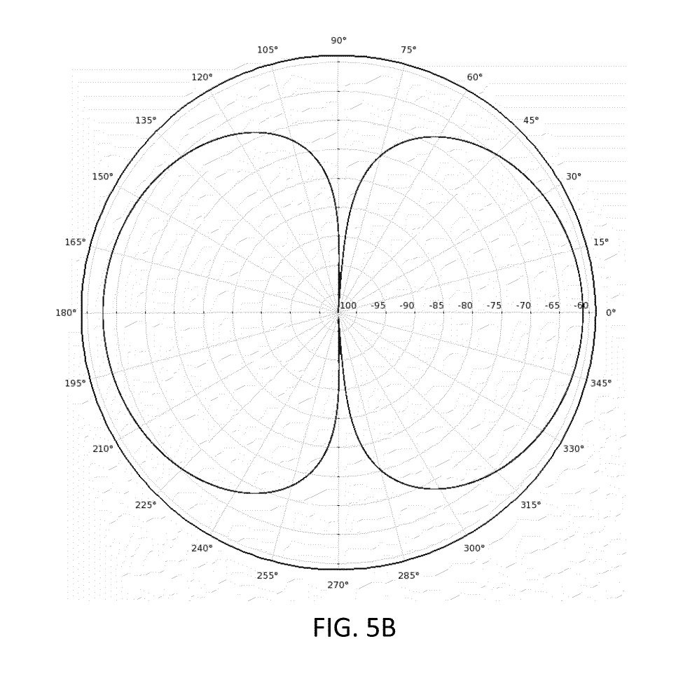

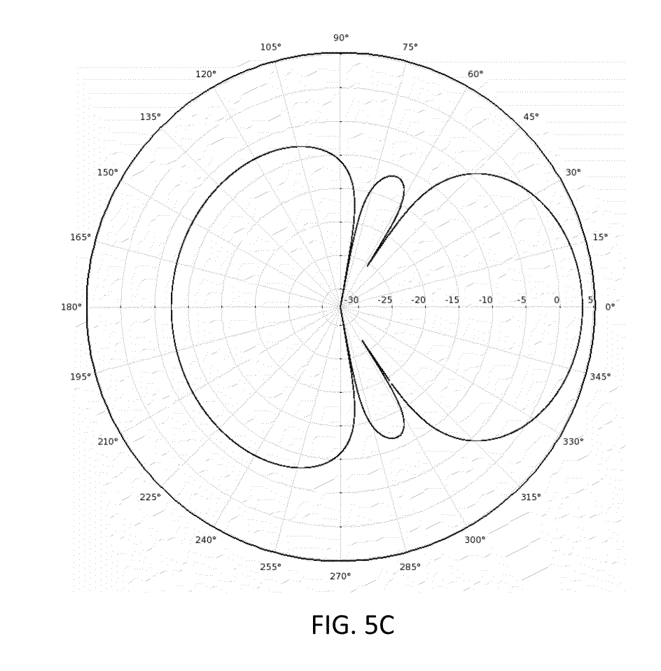

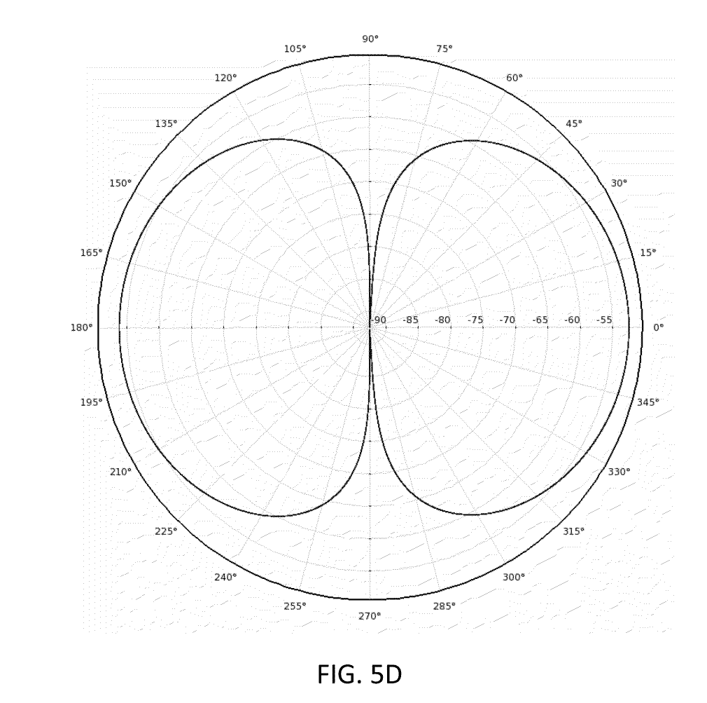

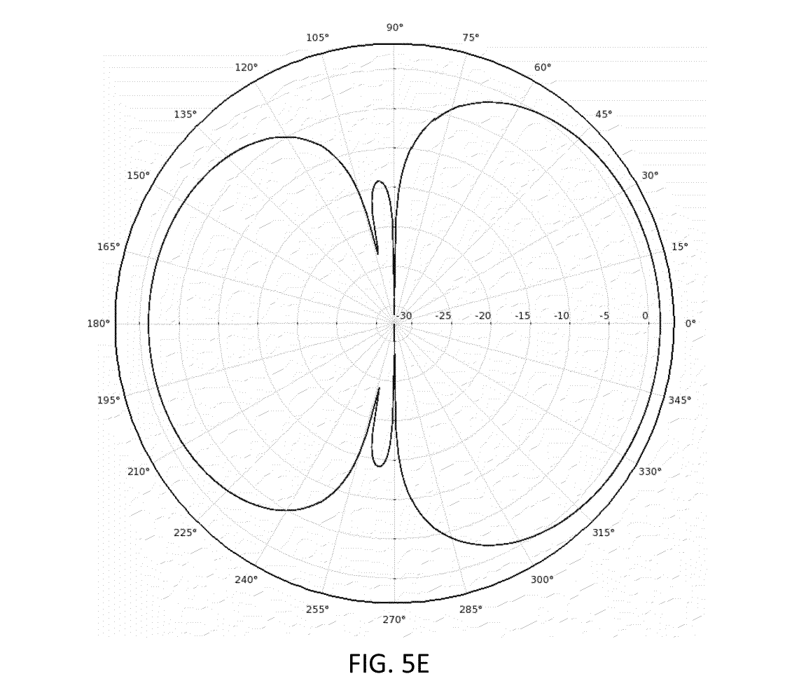

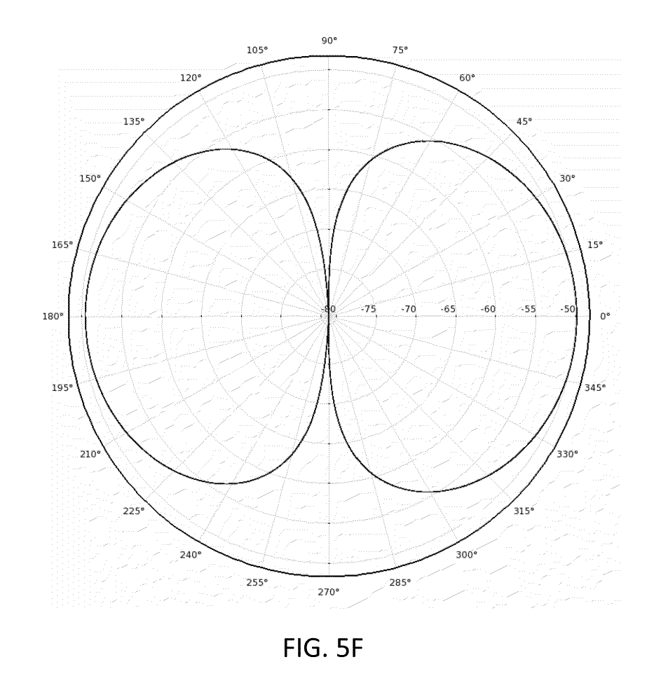

The azimuthal sensitivity of an incomplete circular antenna can be described by its radiation pattern. For example, a current-carrying incomplete circular antenna is located in a homogenous medium which has a resistivity of 100 ohm*m, and the power strength in azimuthal direction at different distances to the center of the incomplete circular antenna with different open angles can be investigated. FIGS. 5A, 5C and 5E illustrate the power strength in logarithm scale 10*log10(|E|*|H|) in azimuthal direction at a distance of 0.5 m with an open angle of 30 degrees, 90 degrees, and 180 degrees respectively, and FIG. 5B, 5D, and 5F illustrates the power strength in logarithm scale 10*log10(|E|*|H|) in azimuthal direction at a distance of 5 m with an open angle of 30 degrees, 90 degrees, and 180s degree respectively (e.g. an open angle 408 of the first antenna 300 shown in FIG. 4B is 90 degrees. However, the present invention is no way limited to any particular degree.).

FIG. 5A shows clearly the directivity of the incomplete circular antenna. The power strength in the direction in which the incomplete circular antenna faces (corresponding to the 0 degree in FIG. 5A) is around 15 dB bigger than the power strength in the direction opposite to the incomplete circular antenna (corresponding to the 180 degrees in FIG. 5A). Comparing FIGS. 5A and 5B, it can be seen that the azimuthal sensitivity of the incomplete circular antenna gets much weaker when the observation location is far away from the center of the incomplete circular antenna (e.g. 5 m). Comparing FIGS. 5C and 5D, and FIGS. 5E and 5F, a similar trend as shown in FIGS. 5A and 5B can also be seen. Furthermore, comparing FIGS. 5A, 5C and 5E, it can be seen that the azimuthal sensitivity decreases with the increase of the open angle of the incomplete circular antenna. However, the power strength increases with the increase of the open angle.

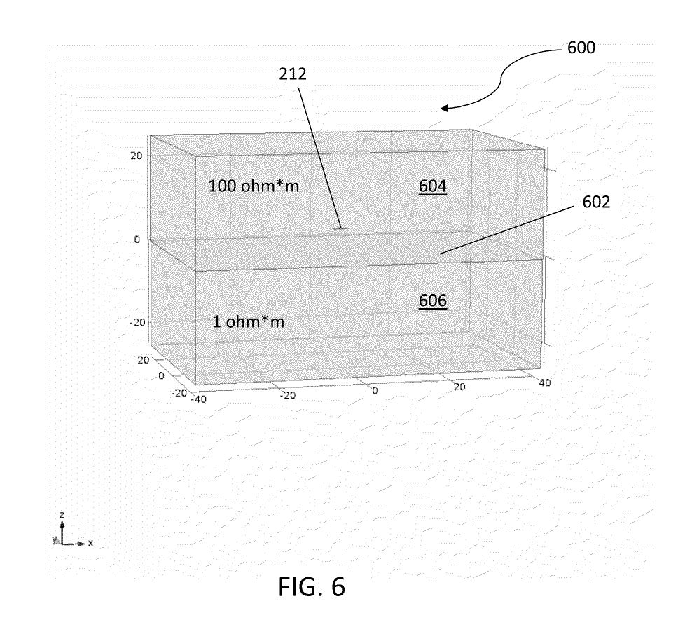

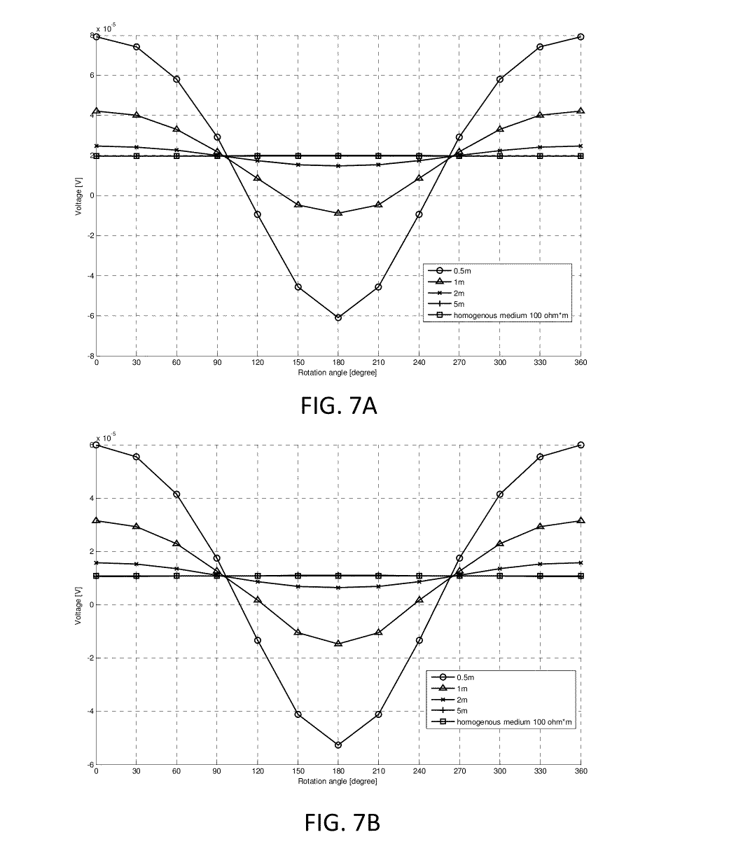

FIG. 6 illustrates an exemplary model used for demonstrating the azimuthal sensitivity of the present invention, and FIGS. 7, 8, and 9 show simulation results of the model provided in FIG. 6. In FIG. 6, the first model 600 can contain a 3D cube divided into two parts by a horizontal resistivity interface 602. The upper part 604 can have a resistivity of 100 ohm*m and the lower part 606 can have a resistivity of 1 ohm*m. The directional resistivity tool 212 depicted in FIG. 3 can be placed in the upper part 604 and approaches to the resistivity interface 602 for simulation.

FIG. 7A illustrates simulation results of the first model 600 in FIG. 6 in terms of a data graph of induced voltage of the second antenna 302 shown in FIG. 3 versus rotation angle of the directional resistivity tool 212 at different vertical distances from the directional resistivity tool 212 to the resistivity interface 602, and FIG. 7B illustrates simulation results of the first model 600 in FIG. 6 in terms of a data graph of induced voltage of the third antenna 304 shown in FIG. 3 versus rotation angle of the directional resistivity tool 212 at different vertical distances from the directional resistivity tool 212 to the resistivity interface 602 according to some embodiments of the present invention. In accordance with FIGS. 7A and 7B, the induced voltage on the second antenna 302 and the third antenna 304, both of which act as a receiver antenna, can vary sinusoidally with the rotation of the directional resistivity tool 212. The peak-valley amplitude of the sinusoidally-varying curves can be related to the distances from the directional resistivity tool 212 to the resistivity interface 602. The closer the directional resistivity tool 212 to the resistivity interface 602, the bigger the peak-valley amplitude of the sinusoidal voltage curve. When the directional resistivity tool 212 is far way from the resistivity interface 602 (e.g. 5 m), the results have little difference from the result derived while the directional resistivity tool 212 is placed in a homogenous medium with a resistivity of 100 ohm*m. The sinusoidally-varying induced voltages on receiver antennas can be related to the rotation angle of the directional resistivity tool 212, and therefore a directional resistivity tool 212 with an incomplete circular antenna can be used for obtaining azimuthal information of electrical properties of a subterranean formation, including, but not limited to, the distance and direction to the resistivity interface.

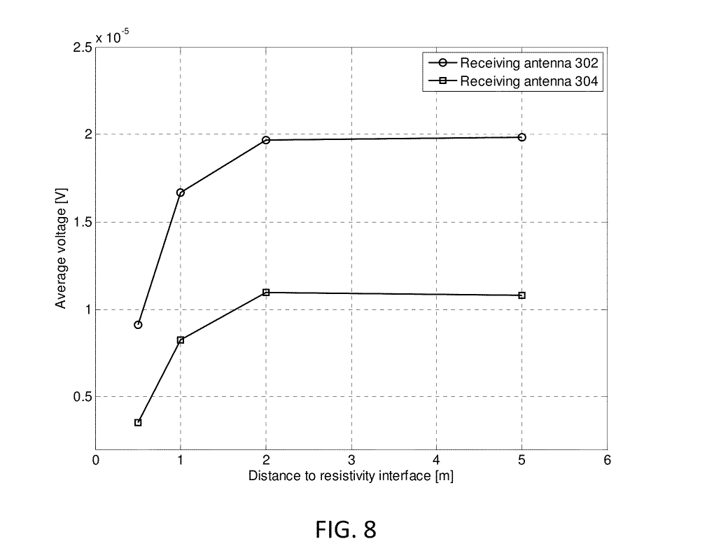

FIG. 8 illustrates simulation results of the first model 600 in FIG. 6 in terms of a data graph of average induced voltages of the second antenna 302 and of the third antenna 304 shown in FIG. 3 versus distance from the directional resistivity tool 212 to the resistivity interface 602 according to some embodiments of the present invention. In accordance with FIG. 8, the closer the directional resistivity tool 212 to the conductive zone 606, the smaller the average induced voltage on the receiver antennas.

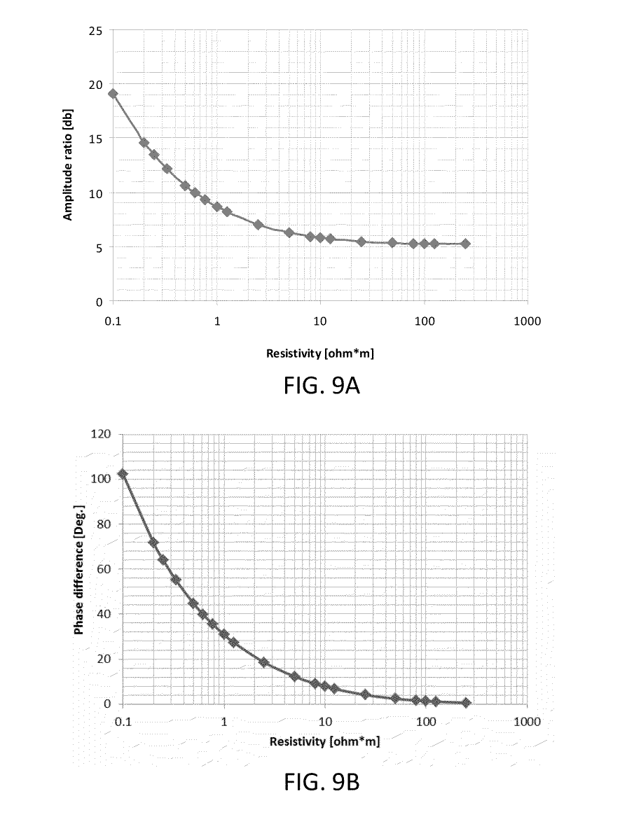

FIG. 9A illustrates simulation results of the first model 600 in FIG. 6 in terms of a data graph of induced voltage amplitude ratio of the second antenna 302 to the third antenna 304 shown in FIG. 3 versus resistivity of surrounding formation of the direction resistivity tool 212, and FIG. 9B illustrates simulation results of the first model 600 in FIG. 6 in terms of a data graph of induced voltage phase shift between the second antenna 302 and the third antenna 304 shown in FIG. 3 versus resistivity of surrounding formation of the directional resistivity tool 202. The above results show that a directional resistivity tool 212 with an incomplete circular antenna can also be used for obtaining resistivity information of the formation adjacent to a borehole.

In some embodiments, an user also can compute the induced voltage amplitude ratio of the first antenna 300 to the second antenna 302 (or the third antenna 304) and the induced voltage phase difference between the first antenna 300 and the second antenna 302 (or the third antenna 304) to obtain resistivity information of the formation adjacent to a borehole.

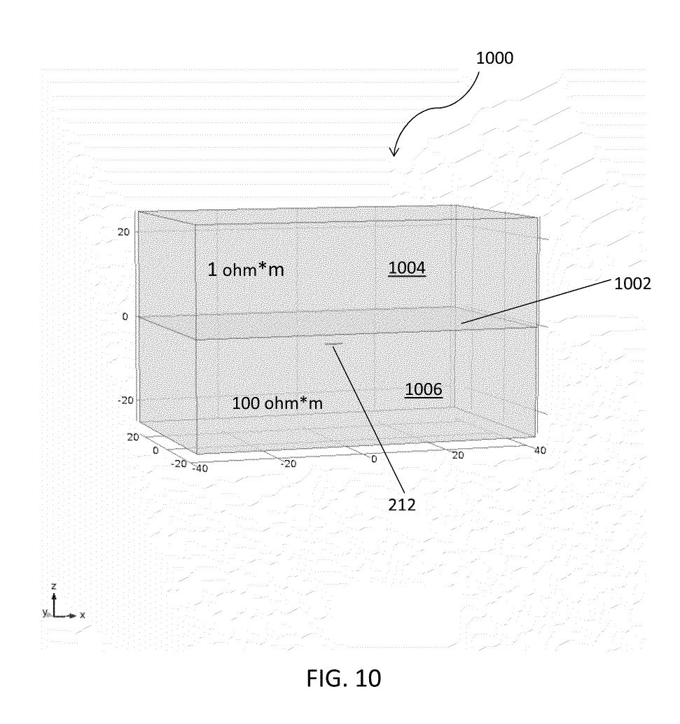

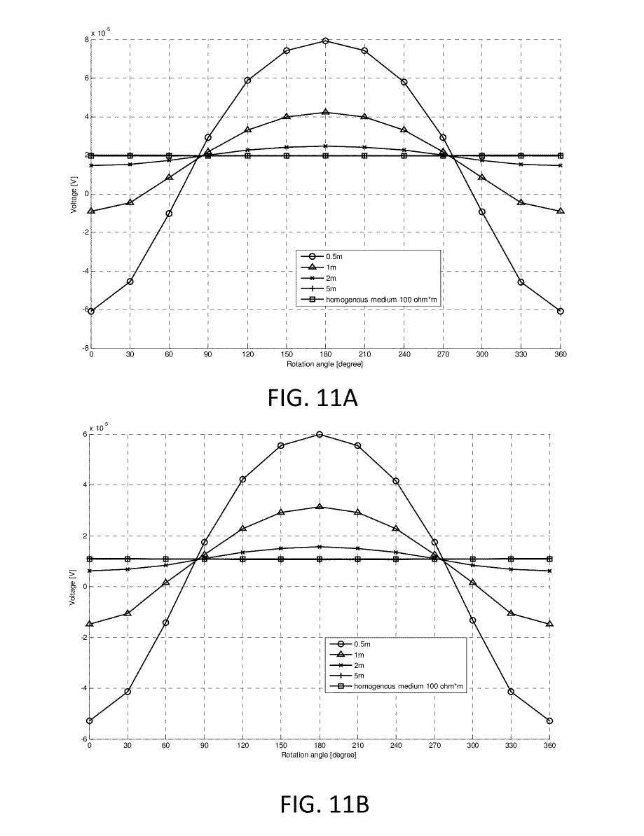

FIG. 10 illustrates another exemplary model used for demonstrating the azimuthal sensitivity of the present invention, and FIGS. 11A and 11B show simulation results of the model provided in FIG. 10. In FIG. 10, the second model 1000 can contain a 3D cube divided into two parts by a horizontal resistivity boundary 1002. The upper portion 1004 can have a resistivity of 1 ohm*m and the lower portion 1006 can have a resistivity of 100 ohm*m. The directional resistivity tool 212 depicted in FIG. 3 can be placed in the lower portion 1006 and approaches to the resistivity boundary 1002 for simulation.

FIG. 11A illustrates simulation results of the second model 1000 in FIG. 10 in terms of a data graph of induced voltage of the second antenna 302 shown in FIG. 3 versus rotation angle of the directional resistivity tool 212 at different vertical distances from the directional resistivity tool 212 to the resistivity boundary 1002, and FIG. 11B illustrates simulation results of the second model 1000 in FIG. 10 in terms of a data graph of induced voltage of the third antenna 304 shown in FIG. 3 versus rotation angle of the directional resistivity tool 212 at different vertical distances from the directional resistivity tool 212 to the resistivity boundary 1002 according to some embodiments of the present invention. Consistent with the results shown in FIGS. 7A and 7B, FIGS. 11A and 11B show that the induced voltage on the second antenna 302 and the third antenna 304, both of which act as a receiver antenna, can vary sinusoidally with the rotation of the directional resistivity tool 212. The peak-valley amplitude of the sinusoidally-varying curves can be related to the distances from the directional resistivity tool 212 to the resistivity boundary 1002. The closer the directional resistivity tool 212 to the resistivity boundary 1002, the bigger the peak-valley amplitude of the sinusoidal voltage curve. When the directional resistivity tool 212 is far way from the resistivity boundary 1002 (e.g. 5 m), the results have little difference from the result derived while the directional resistivity tool 212 is placed in a homogenous medium with a resistivity of 100 ohm*m.

A corresponding method for making directional resistivity measurements of a subterranean formation includes rotating a resistivity tool in a borehole, which includes a first antenna with two open ends oriented substantially perpendicular to a longitudinal axis of the resistivity tool, a second antenna with a coil shape, and the first antenna and the second antenna forming a transmitter-receiver antenna group having a transmitter antenna and a receiver antenna; utilizing the transmitter-receiver antenna group to process an electromagnetic wave, including causing the transmitter antenna to transmit the electromagnetic wave and causing the receiver antenna to receive the electromagnetic wave from the transmitter antenna; and computing a resistivity-related measurement from the electromagnetic wave received on the receiver antenna.

In some embodiments, computing the resistivity-related measurement can include extracting an average value of induced voltages on the receiving antenna during a rotation round of the resistivity tool.

In some embodiments, computing the resistivity-related measurement can further include processing the average value of induced voltages to derive a resistivity of the subterranean formation adjacent to the borehole.

In some embodiments, computing the resistivity-related measurement can include extracting a peak-valley amplitude of induced voltages on the receiver antenna during a rotation round of the resistivity tool and a rotation angle.

In some embodiments, computing the resistivity-related measurement can further include processing the peak-valley amplitude to derive information of distance and direction to an interface from the resistivity tool.

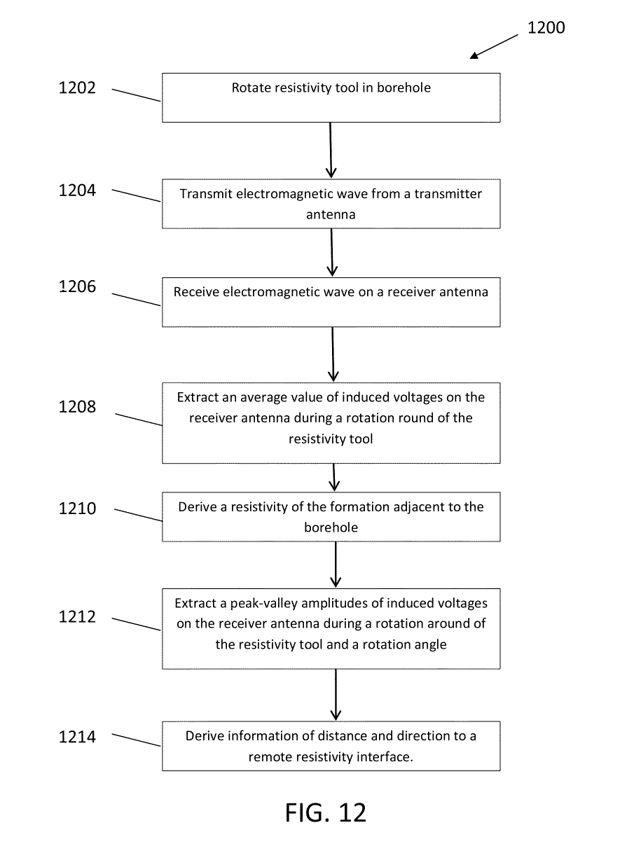

FIG. 12 illustrate of an exemplary flow chart of making directional resistivity measurements 1200 according to some embodiments of the present invention. The steps include rotating a resistivity tool in a borehole 1202, transmitting electromagnetic wave from a transmitter antenna 1204, receiving electromagnetic wave on a receiver antenna 1206, extracting an average value of induced voltages on the receiver antenna during a rotation round of the resistivity tool 1208, deriving a resistivity of the formation adjacent to the borehole 1210, extracting a peak-valley amplitude of induced voltages on the receiver antenna during a rotation round of the resistivity tool and a rotation angle 1212, and deriving information of distance and direction to a remote resistivity interface 1214. However, the present invention is in no way limited to any particular order of steps or requires any particular step illustrated in FIG. 12.

In conclusion, exemplary embodiments of the present invention stated above may provide several advantages as follows. The present invention can provide not only electrical properties of the formation adjacent to the borehole, but also the information of the direction and distance to a remote resistivity interface. Also, the present invention with an incomplete circular antenna configuration does not require any additional transverse antenna, and therefore it only requires small modification on a conventional LWD and/or MWD tools while directional measurements are needed. Accordingly, complexity and cost of fabrication can be decreased.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. An apparatus for making directional resistivity measurements of a subterranean formation comprising:
a resistivity tool body with a longitudinal axis and an outer surface;
a first antenna with two open ends deployed below the outer surface and oriented substantially perpendicular to the longitudinal axis of the resistivity tool body;
a second antenna deployed below the outer surface and spaced at an axial distance from the first antenna; and
at least one slot formed on the outer surface.

2. The apparatus according to claim 1 wherein the slot is oriented substantially parallel to the longitudinal axis of the resistivity tool body.

3. The apparatus according to claim 1 wherein the second antenna is oriented perpendicular to the longitudinal axis of the resistivity tool body.

4. The apparatus according to claim 1 wherein the first antenna operates as a transmitter antenna to transmit an electromagnetic wave or as a receiver antenna to receive the electromagnetic wave.

5. The apparatus according to claim 4 wherein the second antenna operates as the receiver antenna while the first antenna operates as the transmitter antenna.

6. The apparatus according to claim 4 wherein the second antenna operates as the transmitter antenna while the first antenna operates as the receiver antenna.

7. The apparatus according to claim 1 wherein the first antenna is a wire segment deployed substantially perpendicular to the longitudinal axis of the resistivity tool body.

8. The apparatus according to claim 1 wherein the first antenna is an incomplete circular antenna deployed substantially perpendicular to the longitudinal axis of the resistivity tool body.

9. The apparatus according to claim 1 wherein the second antenna is a wire loop deployed substantially perpendicular to the longitudinal axis of the resistivity tool body.

10. The apparatus according to claim 1 wherein pathways of the first antenna and the second antenna traverse the slot.

11. The apparatus according to claim 1 further comprising a permeable material filled in the slot.

12. The apparatus according to claim 11 wherein the permeable material is a magnetic material for enhancing transmission and reception of the first antenna and the second antenna.

13. The apparatus according to claim 12 wherein the magnetic material is selected from the group consisting of a ferrite material, an electrically non-conductive magnetic alloy, an iron powder, and a nickel iron alloy.

14. The apparatus according to claim 1 further comprising a protective material filled in the slot of the resistivity tool body.

15. The apparatus according to claim 14 wherein the protective material is made of epoxy resin.

16. A directional resistivity tool with a tool body and a longitudinal axis comprising:
a wire segment with two open ends placed in the tool body and configured to transmit or receive an electromagnetic wave;
a wire loop placed in the tool body and configured to receive or transmit the electromagnetic wave from or to the wire segment;
at least one slot formed on the periphery of the tool body for housing the wire segment and the wire loop; and
the wire segment formed substantially perpendicular to the longitudinal axis of the tool body.

17. The directional resistivity tool according to claim 16 further comprising a permeable material filled in the slot.

18. The directional resistivity tool according to claim 16 wherein the wire segment and the wire loop operate as an antenna at one or more frequencies.

19. A method for making directional resistivity measurements of a subterranean formation comprising:
rotating a resistivity tool in a borehole, the resistivity tool including a first antenna with two open ends oriented substantially perpendicular to a longitudinal axis of the resistivity tool, a second antenna, and the first antenna and the second antenna forming a transmitter-receiver antenna group having a transmitter antenna and a receiver antenna;
utilizing the transmitter-receiver antenna group to process an electromagnetic wave, including causing the transmitter antenna to transmit the electromagnetic wave and causing the receiver antenna to receive the electromagnetic wave from the transmitter antenna; and
computing a resistivity-related measurement from the electromagnetic wave received on the receiver antenna.

20. The method according to claim 19 wherein computing the resistivity-related measurement comprising extracting an average value of induced voltages on the receiver antenna during a rotation round of the resistivity tool.

21. The method according to claim 20 wherein computing the resistivity-related measurement further comprising processing the average value of induced voltages to derive a resistivity of the subterranean formation adjacent to the borehole.

22. The method according to claim 19 wherein computing the resistivity-related measurement comprising extracting a peak-valley amplitude of induced voltages on the receiver antenna during a rotation round of the resistivity tool and a rotation angle.

23. The method according to claim 22 wherein computing the resistivity-related measurement further comprising processing the peak-valley amplitude to derive an information of distance and direction to an interface from the resistivity tool.
